(19) United States
(12) Patent Application Publication
(10) Pub. No.: US 2024/0348865 A1
(43) Pub. Date: Oct. 17, 2024

(54) METHOD AND APPARATUS FOR GENERATING VIDEO EDITING TEMPLATE, DEVICE, AND STORAGE MEDIUM

(71) Applicant: Beijing Zitiao Network Technology Co., Ltd., Beijing (CN)

(72) Inventors: Xinwei LI, BEIJING (CN); Jianfan ZHAO, BEIJING (CN)

(21) Appl. No.: 18/573,246

(22) PCT Filed: Dec. 7, 2022
(86) PCT No.: PCT/CN2022/137181

§ 371 Date: Dec. 21, 2023

(30) Foreign Application Priority Data
Dec. 9, 2021 (CN) 202111501326.9

(51) Int. Cl. H04N 21/431; H04N 21/2743; H04N 21/854

(52) U.S. Cl. CPC H04N 21/4318; H04N 21/2743; H04N 21/4316; H04N 21/854

(57) ABSTRACT

The present disclosure provides a method and apparatus for generating a video editing template, a device, and a storage medium. The method comprises: first, displaying a template editing page when a trigger operation for a preset template creation control is received; then, generating a storyboard description set when an addition operation for a storyboard shot and/or photographing instruction information performed on the template editing page is received; and generating a target video editing template on the basis of the storyboard description set in order to generate a target result video.

### CROSS REFERENCE TO RELATED APPLICATIONS

The present application is based on and claims priority from the Chinese application under the application number 202111501326.9, which was filed on Dec. 9, 2021, the disclosure of which is incorporated herein by reference to its entirety.

### TECHNICAL FIELD

The present disclosure relates to the field of data processing, and in particular, to a method and an apparatus for generating a video editing template, a device, and a storage medium.

### BACKGROUND

With the popularity of short-video multimedia technology, people's interest in video creation is increasing, and peripheral functions of video creation are becoming more and more abundant in order to satisfy the growing enthusiasm of video creation. For example, video editing templates that provide video authoring scripts to users are receiving increasing attention.

### DISCLOSURE OF THE INVENTION

The present disclosure provides a method for generating a video editing template, which provides a function of creating a video editing template for a user, so that the user can create a video editing template meeting personalized demands on creation by the user.

In a first aspect, the present disclosure provides a method for generating a video editing template, the method comprising:
in response to a trigger operation for a preset template creation control, displaying a template editing page;
in response to an addition operation for at least one of storyboard scenes or shooting indication information on the template editing page, generating a set of storyboard descriptions; wherein the set of storyboard descriptions comprises at least one storyboard scene with a sequential relation, the at least one storyboard scene is respectively provided with shooting indication information, and the shooting indication information is used for indicating at least one of a shooting manner or features of shot content of the storyboard scenes; and
generating a target video editing template based on the set of storyboard descriptions; wherein the target video editing template is used for generating a target result video, the target result video comprising at least one initial video material that is respectively set for at least one storyboard scene in the target video editing template.

In an alternative embodiment, the template editing page comprises a material uploading control, and after generating the set of storyboard descriptions in response to an addition operation for at least one of the storyboard scenes or shooting indication information on the template editing page, the method further comprises:
in response to a start trigger operation for the material uploading control, displaying a material uploading window corresponding to the storyboard scenes in the set of storyboard descriptions on the template editing page; wherein the material uploading window is used for setting initial video materials for storyboard scenes.

In an alternative embodiment, after the displaying, on the template editing page, a material uploading window corresponding to storyboard scenes in the set of storyboard descriptions in response to a start trigger operation for the material uploading control, the method further comprises:
in response to a close trigger operation for the material uploading control, hiding the material uploading window displayed on the template editing page.

In an alternative embodiment, prior to generating the target video editing template based on the set of storyboard descriptions, the method further comprises:
in response to an editing operation for at least one of storyboard scenes or shooting indication information in the set of storyboard descriptions, updating the set of storyboard descriptions; wherein the editing operation comprises at least one of a modification operation, a deletion operation or a sequence adjustment operation.

In an alternative embodiment, prior to generating a target video editing template based on the set of storyboard descriptions, the method further comprises:
receiving video clip description information added on the template editing page for at least one storyboard scenes in the set of storyboard descriptions; wherein the video clip description information is used for indicating a shooting content outline of the at least one storyboard scene;
correspondingly, the generating a target video editing template based on the set of storyboard descriptions comprises:
based on the set of storyboard descriptions and the video clip description information, generating a target video editing template.

In an alternative embodiment, prior to generating the target video editing template based on the set of storyboard descriptions and the video clip description information, the method further comprises:
receiving a speech-line copywriting added to the template editing page for the video clip description information; wherein the speech-line copywriting is used for indicating shooting speech lines for the storyboard scenes corresponding to the video clip description information;
correspondingly, the generating a target video editing template based on the set of storyboard descriptions and the video clip description information comprises:
generating a target video editing template based on the set of storyboard descriptions, the video clip description information and the speech-line copywriting.

In an alternative embodiment, the target video editing template is generated based on a first table, a unit row in the first table having a corresponding relationship with video clip description information, and the unit row being used for storing the video clip description information and shooting indication information for at least one storyboard scene corresponding to the video clip description information; the method further comprises:
in response to a preset selection operation for first video clip description information in the first table, displaying an editing floating window for a unit row corresponding to the first video clip description information; wherein the editing floating window comprises a deletion option; and
in response to a trigger operation for the deletion option on the editing floating window, deleting the unit row and the video clip description information and the shooting indication information for storyboard scenes stored in the unit row.

In an alternative embodiment, the editing floating window further comprises an addition option, and after the displaying the editing floating window for a unit row corresponding to the first video clip description information in response to a preset trigger operation for the first video clip description information in the first table, the method further comprises:
in response to a trigger operation for the addition option on the editing floating window, adding at least one unit row in the first table based on a position at which the unit row is located.

In an alternative embodiment, the unit row in the first table comprises at least one subunit row, where the subunit row has a corresponding relationship with storyboard scene, and the subunit row is used to store at least one of shooting indication information of storyboard scenes or a material uploading window, where the material uploading window is used to set initial video materials for the storyboard scenes; the method further comprises:
in response to a preset selection operation for a first storyboard scene in the first table, displaying the editing floating window for a subunit row corresponding to the first storyboard scene; and
in response to a trigger operation for a deletion option on the editing floating window, deleting the subunit row and at least one of shooting indication information of storyboard scenes or material uploading window stored in the subunit row.

In an alternative embodiment, after the displaying the editing floating window for the subunit row corresponding to the first storyboard scene in response to a preset trigger operation for the first storyboard scene in the first table, the method further comprises:
in response to the trigger operation for an addition option on the editing floating window, adding at least one subunit row in the unit row to which the subunit row belongs based on a position of the subunit row.

In an alternative embodiment, after generating the target video editing template based on the set of storyboard descriptions, the method further comprises:
releasing the target video editing template.

In a second aspect, the present disclosure provides an apparatus for generating a video editing template, the apparatus comprising:
a first display module, configured to display, in response to a trigger operation for a preset template creation control, a template editing page;
a first generation module, configured to generate a set of storyboard descriptions in response to an addition operation for at least one of storyboard scenes or shooting indication information on the template editing page; wherein the set of storyboard descriptions comprises at least one storyboard scene with a sequential relation, the at least one storyboard scene is respectively provided with shooting indication information, and the shooting indication information is used for indicating at least one of a shooting manner or features of shot content of the storyboard scenes; and
a second generation module, configured to generate a target video editing template based on the set of storyboard descriptions; wherein the target video editing template is used for generating a target result video, the target result video comprises at least one initial video material, and the at least one initial video material is respectively set for at least one storyboard scene in the target video editing template.

In a third aspect, the present disclosure provides a computer-readable storage medium having stored thereon instructions that, when executed on a terminal device, cause the terminal device to implement the above-mentioned method.

In a fourth aspect, the present disclosure provides a device comprising: a memory, a processor, and a computer program stored on the memory and executable on the processor, the processor implementing the method when executing the computer program.

In a fifth aspect, the present disclosure provides a computer program product comprising computer programs/instructions which, when executed by a processor, implement the method described above.

### DESCRIPTION OF THE DRAWINGS

The accompanying drawings, which are incorporated in and constitute a part of this description, illustrate embodiments consistent with the present disclosure and, together with the description, serve to explain the principles of the disclosure.

In order to more clearly illustrate the embodiments of the present disclosure or technical solutions in the related art, the drawings used in the description of the embodiments or related technologies will be briefly described below, and apparently, those skilled in the art may obtain other drawings based on these drawings without any inventive labor.

FIG. 1 is a flowchart of a method for generating a video editing template provided by an embodiment of the present disclosure;

FIG. 2 is a schematic diagram of a video editing template display page provided by an embodiment of the present disclosure;

FIG. 3 is a schematic diagram of a template editing page provided by an embodiment of the present disclosure;

FIG. 4 is a schematic diagram of another template editing page provided by an embodiment of the present disclosure;

FIG. 5 is a schematic diagram of a further template editing page provided by an embodiment of the present disclosure;

FIG. 6 is a schematic structural diagram of an apparatus for generating a video editing template provided by an embodiment of the present disclosure;

FIG. 7 is a schematic structural diagram of a device for generating a video editing template provided by an embodiment of the present disclosure.

### EMBODIMENT

In order that the above objects, features and advantages of the present disclosure may be more clearly understood, aspects of the present disclosure will be further described below. It should be noted that, in the case of no conflict, the embodiments and features in the embodiments of the present disclosure may be combined with each other.

In the following description, numerous specific details are set forth in order to provide a thorough understanding of the present disclosure, but the present disclosure may be practiced otherwise than as described herein; apparently, the embodiments disclosed in the description are only a few instead of all embodiments of the present disclosure.

At present, the functions of the video editing template provided for the user gradually cannot meet the personalized demands on creation by the user, and therefore, it is a technical problem to be solved at present how to meet the personalized demands on creation by the user.

In order to meet the user's personalized video creation demand, the present disclosure provides a method for generating a video editing template. First, upon receiving a trigger operation for a preset template creation control, a template editing page is displayed. Then, upon receiving an addition operation for the storyboard scenes and/or shooting indication information on the template editing page, a set of storyboard descriptions is generated. The set of storyboard descriptions comprises at least one storyboard scene with a sequential relation, each storyboard scene being provided with shooting indication information for indicating a shooting manner and/or features of shot content of the storyboard scene. Further, based on the set of storyboard descriptions, a target video editing template is generated for generating a target result video. Therefore, an embodiment of the present disclosure provides a function of creating a video editing template for a user, so that the user can create a video editing template meeting the personalized creation demand of the user, thereby improving the user's video creation experience.

On this basis, an embodiment of the present disclosure provides a method for generating a video editing template. Referring to FIG. 1 that is a flowchart of a method for generating a video editing template provided by an embodiment of the present disclosure, the method comprising:

S101: in response to a trigger operation for a preset template creation control, displaying a template editing page.

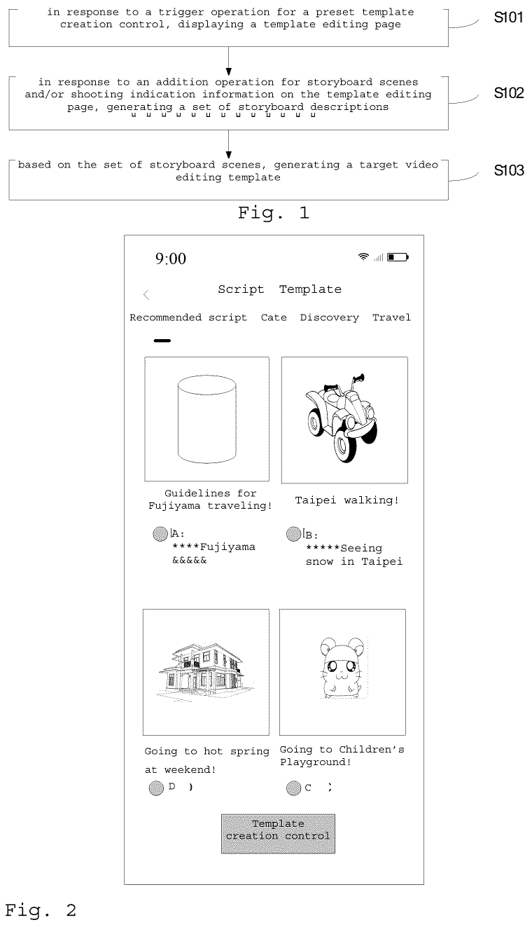

In an embodiment of the present disclosure, the preset template creation control may be a control preset on a video editing template display page. As shown in FIG. 2, which is a schematic diagram of a video editing template display page provided in an embodiment of the present disclosure. The video editing template may also be referred to as a video authoring script, or a script for short. In the process of browsing the video editing template, a user can trigger a jump from the current page to a template editing page by clicking the template creation control on the video editing template display page to display the template editing page.

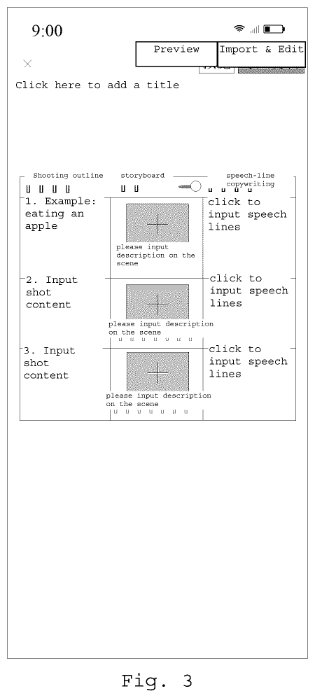

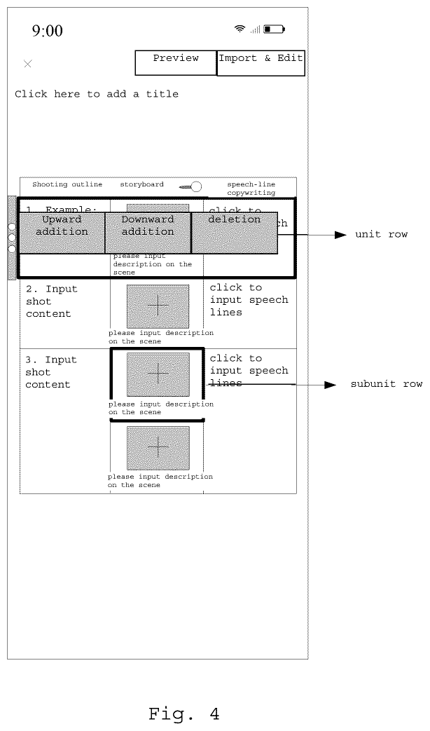

Referring to FIG. 3 that is a schematic diagram of a template editing page provided by an embodiment of the present disclosure, where an empty script is displayed on the video editing page, it may be a default that the video editing template comprises “a shooting outline”, “storyboard scenes” and “a speech-line copywriting”, and a user may complete creation of the script by adding content in the empty script. It should be noted that the video editing page in an embodiment of the present disclosure may also be in other styles, which is not limited in the embodiments of the present disclosure.

S102: in response to an addition operation for the storyboard scenes and/or shooting indication information on the template editing page, generating a set of storyboard description.

Wherein the set of storyboard descriptions comprises at least one storyboard scene with a sequential relation, the at least one storyboard scene being respectively provided with shooting indication information, and the shooting indication information being used for indicating the shooting manner and/or features of shot content of the storyboard scene.

In an embodiment of the present disclosure, storyboard scenes, shooting indication information, and the like may be added on the template editing page, so as to generate a set of storyboard descriptions.

In an alternative embodiment, the shooting indication information has a one-to-one corresponding relation with the storyboard scenes, and the shooting indication information of each storyboard scene is used for indicating the shooting manner, the features of shot content, and the like of the storyboard scene. Wherein the shooting manner may comprise a mirror operation manner, which may specifically comprise handheld self-shooting, left-right panning, follow-shooting and the like; the shooting indication information may also describe features of shot content for the storyboard scenes; for example, the shooting indication information may comprise “ordering”, describing a material for the storyboard scene corresponding to the shooting indication information is “ordering” related content.

In an embodiment of the present disclosure, a material uploading control is provided on the template editing page. As shown in FIG. 3, a user can control a display state of a material uploading window corresponding to the storyboard scene by controlling the material uploading control.

In an alternative embodiment, in response to a start trigger operation for a material uploading control on a template editing page, a material uploading window corresponding to a storyboard scene in a set of storyboard descriptions is displayed on the template editing page. Wherein the material uploading window is used for setting an initial video material for the corresponding storyboard scene. As shown in FIG. 3, the material uploading control is in an initiated state, and at this time, the material uploading window corresponding to the storyboard scene is in a displaying state, and the user can select an initial video material for the corresponding storyboard scene by clicking the material uploading window.

In another alternative embodiment, in order to make the display effect of the template editing page more concise, the user may control the material uploading window on the template editing page to be in a hidden state by closing the material uploading control.

Specifically, in response to a close trigger operation for the material uploading control, the material uploading window displayed on the template editing page is hidden.

S103: generating a target video editing template based on the set of storyboard descriptions.

The target video editing template is used for generating a target result video, the target result video comprising at least one initial video material that is respectively set for at least one storyboard scene in the target video editing template.

In an embodiment of the present disclosure, after the set of storyboard descriptions is generated, a target video editing template may be generated based on storyboard scenes in the set of storyboard descriptions and shooting indication information of the storyboard scenes.

In an alternative embodiment, the target video editing template may be published so that other users can perform video authoring based on the target video editing template.

In another alternative embodiment, after generating the target video editing template, a target result video may be generated based on the target video editing template. Specifically, based on the target video editing template, the user may upload an initial video material for the corresponding storyboard scene by clicking the material uploading window corresponding to each storyboard scene. The initial video material may derive from a user album page, or from a video shooting page.

In the method for generating a video editing template provided by an embodiment of the disclosure, first, upon receiving a trigger operation for a preset template creation control, a template editing page is displayed. Then, upon receiving an addition operation for the storyboard scenes and/or the shooting indication information on the template editing page, a set of storyboard descriptions is generated. Wherein the set of storyboard descriptions comprises at least one storyboard scene with a sequential relation, each storyboard scene being provided with shooting indication information that is used for indicating the shooting manner and/or features of shot content of the storyboard scene. Further, based on the set of storyboard descriptions, a target video editing template is generated, which is used for generating a target result video. Therefore, an embodiment of the present disclosure provides a function of creating a video editing template for a user, so that the user can create a video editing template meeting the personalized creation demand of the user, thereby improving the video creation experience of the user.

Based on the contents of the above-mentioned embodiments, after the set of storyboard descriptions is generated, edition may be performed for the storyboard scenes and the shooting indication information in the set of storyboard descriptions so as to update the set of storyboard descriptions and generate a target video editing template based on the updated set of storyboard descriptions.

In an alternative embodiment, a modification operation, a deletion operation, a sequence adjustment operation, an addition operation and the like may be triggered for the storyboard scenes and/or the shooting indication information in the set of storyboard descriptions.

In addition, in order to enrich video creation indication information provided by the video editing template for the user, in an embodiment of the present disclosure, video clip description information can be added to the storyboard scenes in the set of storyboard descriptions to indicate shooting content outlines of the corresponding storyboard scenes. For example, the video clip description information may be “eating an apple”, and the shooting indication information of the corresponding storyboard scene may comprise shooting indication information of a plurality of storyboard scenes, such as “close-up of the apple”, “expression of the person eating the apple”, and “close-up after eating the apple”.

Specifically, video clip description information added on the template editing page for at least one storyboard scene in the set of storyboard description is received, and then, based on the storyboard scenes in the set of storyboard description and shooting indicating information as well as the video clip description information of the storyboard scenes, a target video editing template is generated. Wherein the target video editing template provides for the user not only shooting indication information of respective storyboard scenes but also video clip description information, which enriches video creation indication information provided by the video editing template for the user and improves the user's video creation experience.

In an alternative embodiment, for the added video clip description information, secondary editing may also be performed, where the secondary editing may comprise deleting, modifying, order adjusting, and the like, for the added video clip description information.

In addition, an embodiment of the present disclosure may further add a speech-line copywriting to the plurality of storyboard scenes corresponding to the video clip description information, so as to indicate shooting speech of the storyboard scenes corresponding to the video clip description information.

Specifically, the speech-line copywriting added to the video clip description information on the template editing page is received, and then a target video editing template can be generated based on the storyboard scenes in the set of storyboard descriptions and shooting indicating information, video clip description information and the speech-line copywriting for the storyboard scenes.

Wherein the target video editing template provides for the user not only shooting indication information and video clip description information for respective storyboard scenes, but also a speech-line copywriting for video creation, which further enriches video creation indication information provided by the video editing template for the user and improves the user's video creation experience.

For the added speech-line copywriting, secondary editing may also be performed, where the secondary editing may comprise deleting, modifying, order adjusting, and the like, for the added speech-line copywriting.

In addition, in order to enable a user to learn the content of the video editing template as a whole, an embodiment of the present disclosure may further add content directories, where each content directory has a corresponding relationship with at least one piece of video clip description information for describing the stage of the video clip corresponding to the at least one piece of video clip description information in the whole video; for example, the content directory may comprise a prologue, a process, a climax, and a result.

For the added content directory, secondary editing may also be performed, where the secondary editing may comprise deleting, modifying, order adjusting, and the like, for the added content directory.

In the method for generating a video editing template provided by an embodiment of the disclosure, a user may add storyboard scenes, and shooting indication information, video clip description information, a speech-line copywriting and a content directory as well as other information of the storyboard scenes on a template editing page based on personalized video creation demands of the user, which instructs the user to perform video creation and improves the user experience.

Based on the content of the embodiments, the embodiments of the present disclosure provide a specific implementation manner of a method for generating a video editing template. Wherein the target video editing template is generated based on a table; as shown in FIG. 4, which is a schematic diagram of another template editing page provided by an embodiment of the present disclosure, a first table is displayed on the template editing page, where the first table by default comprises three columns of “shooting outline”, “storyboard” and “speech-line copywriting”, each unit row in the first table having a corresponding relationship with video clip description information, and each unit row storing one piece of video clip description information, one speech-line copywriting, and one or more storyboard scenes and shooting indication information.

In a practical application, a user may add storyboard scenes and shooting indication information, video clip description information, a speech-line copywriting and the like of storyboard scenes on the template editing page based on basic operations of a table. Further, the user may perform secondary editing on the content that has been added on the template editing page based on the basic operations of the table.

In an alternative embodiment, when a preset selection operation for any piece of video clip description information in a first table on a template editing page is received, an editing floating window is displayed for a unit row where the video clip description information is located. Wherein deletion control and an addition control are displayed on the editing floating window, wherein the addition control may comprise an upward addition control and a downward addition control.

As shown in FIG. 4, when a preset selection operation is triggered for the video clip description information in the first unit row in the first table, the unit row is in a selected state, an editing floating window is displayed at the position of the unit row, and the unit row can be edited based on the editing floating window.

Specifically, in response to a preset selection operation for the first video clip description information in the first table, an editing floating window is displayed for a unit row corresponding to the first video clip description information; wherein the editing floating window comprises a deletion option. In response to a trigger operation for the deletion option on the editing floating window, the unit row and the video clip description information and the shooting indication information of storyboard scenes stored in the unit line are deleted. If a speech-line copywriting is stored in the unit row, the speech-line copywriting is deleted. It can be understood that after the delete option is triggered for the first unit row in FIG. 4, the template editing page is updated from 3 unit rows to 2 unit rows, that is, the first unit row is deleted.

In response to a trigger operation for an addition option on the editing floating window, at least one unit row is added to the first table based on a position where the unit row is located. For example, when an option of upward addition clicked by the user is received, one unit row is added above the currently selected unit row, and in the added unit row, the user may add a storyboard scene and shooting indication information, video clip description information, a speech-line copywriting, and the like of the storyboard scene.

Each unit row in the first table in an embodiment of the present disclosure may comprise one or more subunit rows, each subunit row having a corresponding relationship with the storyboard scene, and each subunit row being configured to store shooting indication information, a material uploading window, and the like of the corresponding storyboard scene. Wherein the material uploading window is used for setting an initial video material for the corresponding storyboard scene.

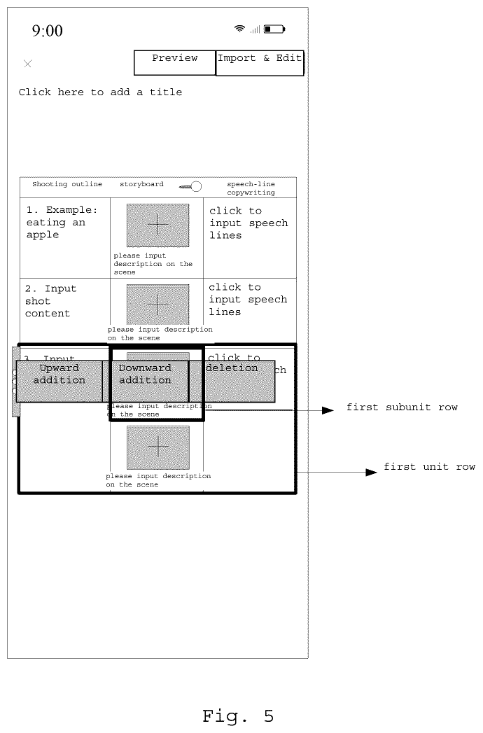

FIG. 5 is a schematic diagram of another template editing page provided in an embodiment of the present disclosure, where a first unit row comprises two subunit rows, where a first storyboard scene corresponding to the first subunit row is in a selected state, and at this time, an editing floating window is displayed for the first subunit row corresponding to the first storyboard scene.

Specifically, when a preset selection operation for a first storyboard scene in the first table is received, an editing floating window is displayed for a subunit row corresponding to the first storyboard scene. When a trigger operation for a deletion option on the editing floating window is received, the subunit row and the shooting indication information and/or the material uploading window of the storyboard scenes stored in the subunit row are deleted. For example, after the deletion option is triggered for the first subunit row shown in FIG. 5, the first subunit row and the content stored therein are deleted, where the first unit row comprises only one subunit row.

In addition, when a trigger operation for an addition option on the editing floating window is received, a new subunit row is added at the position of the corresponding subunit row, and a user can add shooting indication information of storyboard scenes in the subunit row. For example, after a downward addition option is triggered for the first subunit row shown in FIG. 5, one subunit row is added below the first subunit row to store the shooting indication information of the storyboard scenes added by the user, where the first unit row comprises three subunit rows.

Specifically, in response to a trigger operation for an addition option on the editing floating window, at least one subunit row is added in the unit row to which the corresponding subunit row belongs based on the position of the corresponding subunit row.

In an embodiment of the present disclosure, the user can create a video editing template based on basic operations of the table; the operation is simple and convenient, thereby improving the user's experience of creating the video editing template and experience of subsequent video creation.

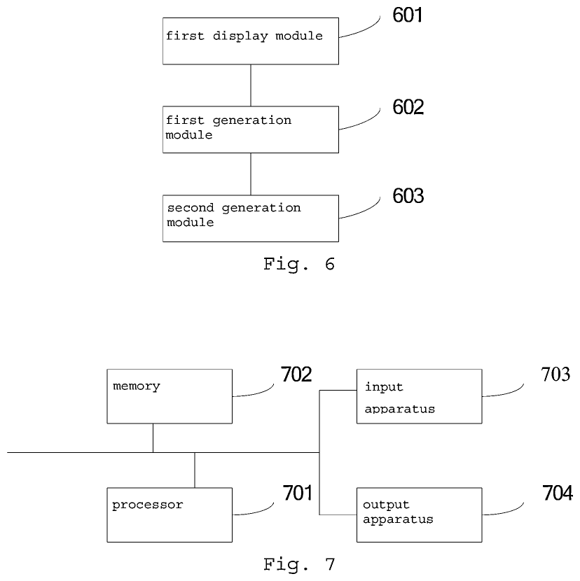

Based on the same inventive concept as the above method embodiment, the present disclosure further provides an apparatus for generating a video editing template; with reference to FIG. 6, which is a schematic structural diagram showing an apparatus for generating a video editing template provided in an embodiment of the present disclosure, the apparatus comprising:
a first display module 601, configured to display a template editing page in response to a trigger operation for a preset template creation control;
a first generation module 602, used to generate a set of storyboard descriptions in response to an addition operation for a storyboard scene and/or shooting indication information on the template editing page; wherein the set of storyboard descriptions comprises at least one storyboard scene with a sequential relation, the at least one storyboard scene being respectively provided with shooting indication information for indicating a shooting manner and/or features of shot content of the storyboard scenes; and
a second generation module 603, used to generate a target video editing template based on the set of storyboard descriptions; wherein the target video editing template is used for generating a target result video that comprises at least one initial video material respectively set for at least one storyboard scene in the target video editing template.

In an alternative embodiment, the template editing page comprises a material uploading control, and the apparatus further comprises:
a second display module, used to display, in response to a start trigger operation for the material uploading control, a material uploading window corresponding to the storyboard scenes in the set of storyboard descriptions on the template editing page; wherein the material uploading window is used for setting an initial video material for storyboard scenes.

In an alternative embodiment, the apparatus further comprises:
a hiding module, used to hide, in response to a close trigger operation for the material uploading control, a material uploading window displayed on the template editing page.

In an alternative embodiment, the apparatus further comprises:
an updating module, used to update, in response to an editing operation for the storyboard scenes and/or the shooting indication information in the set of storyboard descriptions, the set of storyboard descriptions; wherein the editing operation comprises a modification operation, a deletion operation and/or a sequence adjustment operation.

In an alternative embodiment, the apparatus further comprises:
a first receiving module, used to receive video clip description information added on the template editing page for at least one storyboard scene in the set of storyboard descriptions; wherein the video clip description information is used for indicating a shooting content outline of the at least one storyboard scene;
correspondingly, the second generation module is specifically used to:
generate a target video editing template based on the set of storyboard descriptions and the video clip description information.

In an alternative embodiment, the apparatus further comprises:
a second receiving module, used to receive a speech-line copywriting added on the template editing page for video clip description information; wherein the speech-line copywriting is used for indicating shooting speech lines of the storyboard scenes corresponding to the video clip description information;
correspondingly, the second generation module is specifically used to:
generate a target video editing template based on the set of storyboard descriptions, the video clip description information and the speech-line copywriting.

In an alternative embodiment, the target video editing template is generated based on a first table, unit rows in the first table having a corresponding relationship with video clip description information, and the unit row being used for storing the video clip description information and shooting indication information of at least one storyboard scene corresponding to the video clip description information; the apparatus further comprises:
a third display module, used to display, in response to a preset selection operation for first video clip description information in the first table, an editing floating window for a unit row corresponding to the first video clip description information; wherein the editing floating window comprises a deletion option; and
a first deleting module, used to delete the unit row and video clip description information and shooting indication information of storyboard scenes stored in the unit row in response to a trigger operation for the deletion option on the editing floating window.

In an alternative embodiment, the editing floating window further comprises an addition option, and the apparatus further comprises:
a first adding module, used to add at least one unit row in the first table based on a position of the unit row in response to a trigger operation for the addition option on the edit floating window.

In an alternative embodiment, the unit rows in the first table comprise at least one subunit row, where the subunit row has a corresponding relationship with a storyboard scene, the subunit row is used to store shooting indication information and/or a material uploading window of the storyboard scenes, and the material uploading window is used to set an initial video material for the storyboard scenes; the apparatus further comprises:
a fourth display module, used to display, in response to a preset selection operation for a first storyboard scene in the first table, the editing floating window for a subunit row corresponding to the first storyboard scene; and
a second deleting module, used to delete the subunit row and the shooting indication information and/or the material uploading window of the storyboard scenes stored in the subunit line in response to a trigger operation for the deletion option on the editing floating window.

In an alternative embodiment, the apparatus further comprises:
a second adding module, used to add, in response to a trigger operation for an addition option on the editing floating window, at least one subunit row in the unit row to which the subunit row belongs based on a position of the subunit row.

In an alternative embodiment, the apparatus further comprises:
a releasing module, used to release the target video editing template.

In the apparatus for generating a video editing template provided in an embodiment of the present disclosure, first, when a trigger operation for a preset template creation control is received, a template editing page is displayed. Then, upon receiving an addition operation for the storyboard scenes and/or the shooting indication information on the template editing page, a set of storyboard descriptions is generated. Wherein the set of storyboard descriptions comprises at least one storyboard scene with a sequential relation, each storyboard scene being provided with shooting indication information, and the shooting indication information being used for indicating the shooting manner and/or features of shot content of the storyboard scene. Further, a target video editing template is generated based on the set of storyboard descriptions for generating a target result video. Therefore, the embodiments of the present disclosure provide a function of creating a video editing template for a user, so that the user can create a video editing template meeting the user's personalized creation demands, and thus, the video creation experience of the user is improved.

In addition to the method and the apparatus, an embodiment of the present disclosure further provides a computer-readable storage medium having instructions stored thereon, which, when executed on a terminal device, cause the terminal device to implement a method for generating a video editing template according to an embodiment of the present disclosure.

An embodiment of the present disclosure further provides a computer program product, which comprises computer programs/instructions, which, when executed by a processor, implements a method for generating a video editing template according to an embodiment of the present disclosure.

In addition, an embodiment of the present disclosure further provides a device for generating a video editing template, and as shown in FIG. 7, the device may comprise:
a processor 701, a memory 702, an input apparatus 703, and an output apparatus 704. The number of processors 701 in the device for generating the video editing template may be one or more, and one processor is taken as an example in FIG. 7. In some embodiments of the present disclosure, the processor 701, the memory 702, the input apparatus 703 and the output apparatus 704 may be connected via a bus or other means, wherein a bus connection is taken as an example in FIG. 7.

The memory 702 may be used to store software programs and modules, and the processor 701 executes various functional applications and data processing of the device for generating a video editing template by operating the software programs and modules stored in the memory 702. The memory 702 may mainly comprise a program storage area and a data storage area, wherein the program storage area may store an operating system, an application required for at least one function, and the like. Further, the memory 702 may comprise a cache, and may also comprise a non-volatile memory, such as at least one magnetic disk storage device, flash memory device, or other volatile solid-state storage devices. The input apparatus 703 may be used to receive input numeric or character information and to generate signal inputs relating to user settings and function controls of the device for generating the video editing template.

Specifically, in this embodiment, the processor 701 loads executable files corresponding to processes of one or more applications into the memory 702 according to the following instructions, and the processor 701 executes the applications stored in the memory 702, thereby implementing various functions of the device for generating a video editing template.

It is to be noted that, in this document, relational terms such as “first” and “second” are used solely to distinguish one entity or action from another entity or action without necessarily requiring or implying any actual relationship or order between such entities or actions. Also, the terms “comprising”, “including” or any other variations thereof, are intended to cover a non-exclusive inclusion, such that a process, method, article, or device that comprises a list of elements does not comprise only those elements but may comprise other elements not expressly listed or inherent to such process, method, article, or apparatus. Without further limitation, an element defined by the phrase “comprising a/an . . . ” does not exclude the presence of other identical elements in the process, method, article, or apparatus that comprises the element.

The previous description is only for the purpose of describing particular embodiments of the present disclosure, so as to enable those skilled in the art to understand or implement the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest range consistent with the principles and novel features disclosed herein.

1. A method for generating a video editing template, the method comprising:
displaying a template editing page in response to a trigger operation for a preset template creation control;
generating a set of storyboard descriptions in response to an addition operation for at least one of storyboard scenes or shooting indication information on the template editing page; wherein the set of storyboard descriptions comprises at least one storyboard scene with a sequential relation, and the at least one storyboard scene comprises respective shooting indication information used for indicating at least one of a shooting manner or features of shot content of the storyboard scene; and
generating a target video editing template based on the set of storyboard descriptions; wherein the target video editing template is configured to generate a target result video, wherein the target result video comprises at least one initial video material, and the at least one initial video material is respectively set for at least one storyboard scene in the target video editing template.

2. The method according to claim 1, wherein the template editing page comprises a material uploading control thereon, and the method further comprises, after the generating a set of storyboard descriptions in response to an add operation on the template editing page for at least one of storyboard scenes or shooting indication information:
displaying a material uploading window corresponding to the storyboard scenes in the set of storyboard descriptions on the template editing page in response to a start trigger operation for the material uploading control; wherein the material uploading window is configured to set initial video materials for the storyboard scenes.

3. The method according to claim 2, wherein the method further comprises, after the displaying a material uploading window corresponding to the storyboard scenes in the set of storyboard descriptions on the template editing page in response to a start trigger operation for the material uploading control:
hiding the material uploading window displayed on the template editing page in response to a close trigger operation for the material uploading control.

4. The method according to claim 1, wherein prior to the generating a target video editing template based on the set of storyboard descriptions, the method further comprises:
updating the set of storyboard descriptions in response to an editing operation for at least one of storyboard scenes in the set of storyboard descriptions or shooting indication information; wherein the editing operation comprises at least one of a modification operation, a deletion operation or a sequence adjustment operation.

5. The method according to claim 1, wherein prior to the generating a target video editing template based on the set of storyboard descriptions, the method further comprises:
receiving video clip description information added on the template editing page for at least one storyboard scene in the set of storyboard descriptions; wherein the video clip description information is used for indicating a shooting content outline of the at least one storyboard scene;
correspondingly, the generating a target video editing template based on the set of storyboard descriptions comprises:
generating a target video editing template based on the set of storyboard descriptions and the video clip description information.

6. The method according to claim 5, wherein prior to the generating the target video editing template based on the set of storyboard descriptions and the video clip description information, the method further comprises:
receiving a speech-line copywriting added on the template editing page for the video clip description information; wherein the speech-line copywriting is used for indicating shooting speech lines of the storyboard scenes corresponding to the video clip description information;
correspondingly, the generating a target video editing template based on the set of storyboard descriptions and the video clip description information comprises:
generating a target video editing template based on the set of storyboard descriptions, the video clip description information and the speech-line copywriting.

7. The method according to claim 5, wherein the target video editing template is generated based on a first table, a unit row in the first table having a corresponding relationship with the video clip description information, the unit row being configured to store the video clip description information and shooting indication information of at least one storyboard scene corresponding to the video clip description information; the method further comprises:
displaying an editing floating window for a unit row corresponding to first video clip description information in response to a preset selection operation for the first video clip description information in the first table; wherein the editing floating window comprises a deletion option; and
in response to a trigger operation for the deletion option on the editing floating window, deleting the unit row and video clip description information and shooting indication information of the storyboard scene stored in the unit row.

8. The method according to claim 7, wherein the editing floating window further comprises an addition option, and the method further comprises, after the displaying an editing floating window for a unit row corresponding to first video clip description information in response to a preset trigger operation for the first video clip description information in the first table:
adding at least one unit row in the first table based on a position at which the unit row is located in response to a trigger operation for the addition option on the editing floating window.

9. The method according to claim 7, wherein the unit row in the first table comprises at least one subunit row, the subunit row having a corresponding relationship with a storyboard scene, the subunit row being configured to store at least one of shooting indication information of the storyboard scene or a material uploading window configured to set initial video materials for the storyboard scene; the method further comprises:
displaying the editing floating window for a subunit row corresponding to a first storyboard scene in response to a preset selection operation for the first storyboard scene in the first table; and
deleting the subunit row and at least one of the shooting indication information of the storyboard scene or the material uploading window stored in the subunit row in response to a trigger operation for a deletion option on the editing floating window.

10. The method according to claim 9, wherein the method further comprises, after the displaying the editing floating window for a subunit row corresponding to a first storyboard scene in response to a preset selection operation for the first storyboard scene in the first table:
adding at least one subunit row in the unit row to which the subunit row belongs based on a position of the subunit row in response to a trigger operation for an addition option on the editing floating window.

11. The method according to claim 1, wherein the method further comprises, after the generating a target video editing template based on the set of storyboard descriptions:
releasing the target video editing template.

12. (canceled)

13. A non-transitory computer-readable storage medium having stored thereon instructions which, when executed on a terminal device, cause the terminal device to carry out a method for generating a video editing template, the method comprising:
displaying a template editing page in response to a trigger operation for a preset template creation control;
generating a set of storyboard descriptions in response to an addition operation for at least one of storyboard scenes or shooting indication information on the template editing page; wherein the set of storyboard descriptions comprises at least one storyboard scene with a sequential relation, and the at least one storyboard scene comprises respective shooting indication information used for indicating at least one of a shooting manner or features of shot content of the storyboard scene; and
generating a target video editing template based on the set of storyboard descriptions; wherein the target video editing template is configured to generate a target result video, wherein the target result video comprises at least one initial video material, and the at least one initial video material is respectively set for at least one storyboard scene in the target video editing template.

14. An apparatus, comprising: a memory, a processor, and computer programs stored on the memory and executable on the processor, the processor implementing a method for generating a video editing template when executing the computer programs, the method comprising:
displaying a template editing page in response to a trigger operation for a preset template creation control;
generating a set of storyboard descriptions in response to an addition operation for at least one of storyboard scenes or shooting indication information on the template editing page: wherein the set of storyboard descriptions comprises at least one storyboard scene with a sequential relation, and the at least one storyboard scene comprises respective shooting indication information used for indicating at least one of a shooting manner or features of shot content of the storyboard scene; and
generating a target video editing template based on the set of storyboard descriptions: wherein the target video editing template is configured to generate a target result video, wherein the target result video comprises at least one initial video material, and the at least one initial video material is respectively set for at least one storyboard scene in the target video editing template.

15. (canceled)

16. The non-transitory computer-readable storage medium according to claim 13, wherein the template editing page comprises a material uploading control thereon, and the method further comprises, after the generating a set of storyboard descriptions in response to an add operation on the template editing page for at least one of storyboard scenes or shooting indication information:
displaying a material uploading window corresponding to the storyboard scenes in the set of storyboard descriptions on the template editing page in response to a start trigger operation for the material uploading control; wherein the material uploading window is configured to set initial video materials for the storyboard scenes.

17. The non-transitory computer-readable storage medium according to claim 16, wherein the method further comprises, after the displaying a material uploading window corresponding to the storyboard scenes in the set of storyboard descriptions on the template editing page in response to a start trigger operation for the material uploading control:
hiding the material uploading window displayed on the template editing page in response to a close trigger operation for the material uploading control.

18. The non-transitory computer-readable storage medium according to claim 13, wherein prior to the generating a target video editing template based on the set of storyboard descriptions, the method further comprises:
updating the set of storyboard descriptions in response to an editing operation for at least one of storyboard scenes in the set of storyboard descriptions or shooting indication information; wherein the editing operation comprises at least one of a modification operation, a deletion operation or a sequence adjustment operation.

19. The non-transitory computer-readable storage medium according to claim 13, wherein prior to the generating a target video editing template based on the set of storyboard descriptions, the method further comprises:
receiving video clip description information added on the template editing page for at least one storyboard scene in the set of storyboard descriptions; wherein the video clip description information is used for indicating a shooting content outline of the at least one storyboard scene;
correspondingly, the generating a target video editing template based on the set of storyboard descriptions comprises:
generating a target video editing template based on the set of storyboard descriptions and the video clip description information.

20. The apparatus according to claim 14, wherein the template editing page comprises a material uploading control thereon, and the method further comprises, after the generating a set of storyboard descriptions in response to an add operation on the template editing page for at least one of storyboard scenes or shooting indication information:
displaying a material uploading window corresponding to the storyboard scenes in the set of storyboard descriptions on the template editing page in response to a start trigger operation for the material uploading control; wherein the material uploading window is configured to set initial video materials for the storyboard scenes.

21. The apparatus according to claim 20, wherein the method further comprises, after the displaying a material uploading window corresponding to the storyboard scenes in the set of storyboard descriptions on the template editing page in response to a start trigger operation for the material uploading control:
hiding the material uploading window displayed on the template editing page in response to a close trigger operation for the material uploading control.

22. The apparatus according to claim 14, wherein prior to the generating a target video editing template based on the set of storyboard descriptions, the method further comprises:
updating the set of storyboard descriptions in response to an editing operation for at least one of storyboard scenes in the set of storyboard descriptions or shooting indication information; wherein the editing operation comprises at least one of a modification operation, a deletion operation or a sequence adjustment operation.
